(19) United States
(12) Patent Application Publication
(10) Pub. No.: US 2006/0039407 A1
(43) Pub. Date: Feb. 23, 2006

(54) Session continuity

(75) Inventors: Sandro Grech, Helsinki (FI); Roman Pichna, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/003,479

(22) Filed: Dec. 6, 2004

(30) Foreign Application Priority Data
Aug. 23, 2004 (FI) 20041104

(51) Int. Cl. H04J 3/16

(52) U.S. Cl. 370/469; 370/328

(57) ABSTRACT

Session continuity is supported by placing suitable functionality in a communications device and a communications system. In a communications device, a first interface is provided for transmitting data via an access network. A virtual interface corresponding to the first interface also is provided. Communications via the access network take place using the first interface and sending data between the first interface and the virtual interface. In a communications network, it is detected that a communications device is establishing communications via an access network. A network address used earlier by the communications device is determined, and the network address is retained when the communications device communicates via the access network.

### BACKGROUND OF THE INVENTION

1. Field of the Invention

The present invention relates to supporting session continuity. In particular, the present invention relates to supporting session continuity when a communications device is changing access networks or when coverage of an access network is temporarily lost.

2. Description of the Related Art

A communication system can be seen as a facility that enables communication sessions between two or more entities such as user equipment (a communications device) and/or other nodes associated with the communication system. The communication may comprise, for example, communication of voice, data, multimedia and so on. Communication systems providing wireless communication for user equipment are known. An example of the wireless systems is the public land mobile network (PLMN). Another example is the wireless local area network (WLAN).

Multi-access refers to ability to use multiple different access networks with a single communications device. The communications device may, for example, be connected to the Internet at first using a WLAN and, when outside the coverage of the WLAN network, using a cellular communications network.

Session continuity refers to maintaining upper level connections, for example transport level connection, when the access technology, that is the link layer, changes. This means, for example, that applications in a communications device or user of a communications device does not notice change in access technology or interruptions in connectivity.

FIG. 1a shows, as an example, a communications device 101 capable of communicating through at least two different access networks 10a, 10b. Such a communications device is often called a multi-access (MA) device. The first access network 10a in FIG. 1a is a cellular packet access network, and it is associated with a packet switched core network 22 of the cellular network. The specific network elements shown in FIG. 1a are network elements of a General Packet Radio Service (GPRS). The network element facing the access network 10a is a Serving GPRS Support Node (SGSN) and the network element 21 connecting the packet switched core network 22 to a public packet data network 30 (Internet in FIG. 1a) is a Gateway GPRS Support Node (GGSN). FIG. 1a also shows a GPRS Tunnelling Protocol (GTP) tunnel. FIG. 1a also shows a second access network 10b, which in FIG. 1a is a WLAN. The WLAN network is connected to the public data network 30 by a WLAN gateway 11.

Consider a situation, where a communications device 101 first has a communication link with the first access network 10a. In this case, data transmission between the communications device 101 and, for example, a server connected to the public data network 30, is possible via the first access network 10a. When the communications device 101 moves within the coverage area of the first access network 10a, which is a cellular network in this example, the mobility management procedures of the cellular network handle the mobility and provide support for session continuity. When the communications device 101 moves out of the coverage area of the first access network 10a, or otherwise selects to use a different access network, it loses communications via the first access network 10a.

If the communications device 101 is a multi-access device, it may establish a communication link with the second access network 10b when moving out of the coverage area of the first access network 10a or when noticing that the signal quality (and/or other relevant parameters) provided by the second access network 10b is better than that provided by the first access network 10a.

In general, however, the network address (the Internet Protocol (IP) address, in this context) of the communications device changes, when a communications device moves from the first access network 10a to the second access network 10b. This is a problem for session continuity, as the network address is one of the parameters which generally define a session. When the network address changes, it is usually determined that connectivity has been lost and the session is terminated. The communications device, or applications in the communications device, should thus initiate new sessions after changing access networks.

In addition, the TCP/IP protocol stack is typically bound to a specific network interface. Consequently, sessions are disrupted if network connectivity is shifted across network interfaces.

FIG. 1b shows one example of providing session continuity for a moving communications device, namely the Mobile IP protocol. FIG. 1b shows a Home network 50 and Home Agent 51 of the communications device 101. The Home network, Home Agent, and Foreign Agent are all entities defined in the Mobile IP protocol. The Foreign Agent is an optional function in Mobile IPv4, and it may be co-located at the gateways 11 and 21. When the communications device 101 is roaming outside the Home network, the Mobile IP protocol takes care that data packets relating to the communications device's home IP address are routed from the home network 50 to the mobile device's registered care-of address. The communications device 101 may thus use the same home IP address irrespective of its location.

There are, however, challenges relating to the use of Mobile IP. As an example, the Mobile IP provisioning functionality at the network end. Furthermore, the Mobile IP causes extra headers relating to tunneling to be present in data packets. This causes overhead to data transfer.

A very general approach to managing connections or sessions is to use sockets. A socket is a (host, service) pair. The host here refers to a server or other computing device, and the service is a process running on the host device. The host is either a name of a host or a network address, generally an IP address. The service is either a name of a service or a port number. A socket is said to be active until the connection is terminated, either deliberately or due to a time-out. Typical implementations do not support maintaining active sockets when a change in the access technology occurs. Closing a socket means terminating a session, so session continuity cannot be supported here.

There are thus at least the above discussed problems in providing session continuity for multi-access communications device.

### SUMMARY OF THE INVENTION

The present invention aims to provide a complementary solution for supporting session continuity for multi-access communications device.

A first aspect of the present invention provides a method for supporting session continuity, the method comprising
providing a first interface in a communications device for transmitting data via an access network,
providing in the communications device a virtual interface corresponding to the first interface,
communicating via the access network using the first interface, and
sending data between the first interface and the virtual interface.

A second aspect of the invention provides a computer program comprising program instructions for causing a computing device to perform the method of any of the appended method claims.

A third aspect of the invention provides a communications device configured to
provide a first interface for transmitting data via an access network,
provide a virtual interface corresponding to the first interface,
communicate via the access network using the first interface, and
send data between the first interface and the virtual interface.

A fourth aspect of the invention provides a method for supporting session continuity, the method comprising
detecting a communications device establishing communications via an access network,
determining a network address used earlier by the communications device, and
retaining said network address when the communications device communicates via said access network.

A fifth aspect of the invention provides a network element configured to
connect at least one access network to a packet data network,
detect a communications device establishing communications via an access network,
determine a network address used earlier by the communications device, and
retain said network address for the communications device when communicating via said access network.

A sixth aspect of the invention provides a communications system comprising at least one access network, said communications system configured to
connect said at least one access network to a packet data network for providing connectivity to communications devices,
detect a communications device establishing communications via an access network of the communications system,
determine a network address used earlier by the communications device, and
retain said network address for the communications device when communicating via said access network.

### BRIEF DESCRIPTION OF THE DRAWINGS

Embodiments of the present invention will now be described by way of example only with reference to the accompanying drawings, in which:

FIG. 1a shows schematically a communication system in accordance with prior art;

FIG. 1b shows schematically a communications system implementing Mobile IP;

FIG. 2 shows schematically a protocol stack of a multi-access communications device where embodiments of the present invention are applicable;

FIG. 3 shows, as an example, a communications system where embodiments of the present invention are applicable;

FIG. 4 shows schematically functionality in a multi-access communications device in accordance with an embodiment of the invention;

FIG. 5a shows a flowchart of a method in accordance with an embodiment of the invention;

FIG. 5b shows a flowchart of a method in accordance with an embodiment of the invention;

FIG. 6a shows a flowchart relating to further details of a method in accordance with an embodiment of the invention;

FIG. 6b shows a flowchart relating to alternative further details of a method in accordance with an embodiment of the invention;

FIG. 7 shows, as a more detailed example, a further communications system where embodiments of the present invention are applicable;

FIG. 8 shows a flowchart relating to a method in accordance with a further embodiment of the invention; and

FIG. 9 shows schematically a communications system and a communications device providing functionality in accordance with an even further embodiment of the invention.

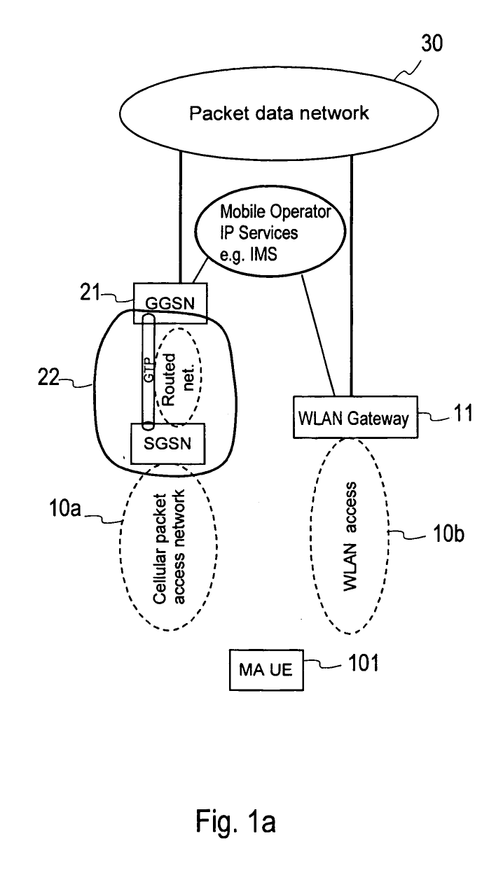

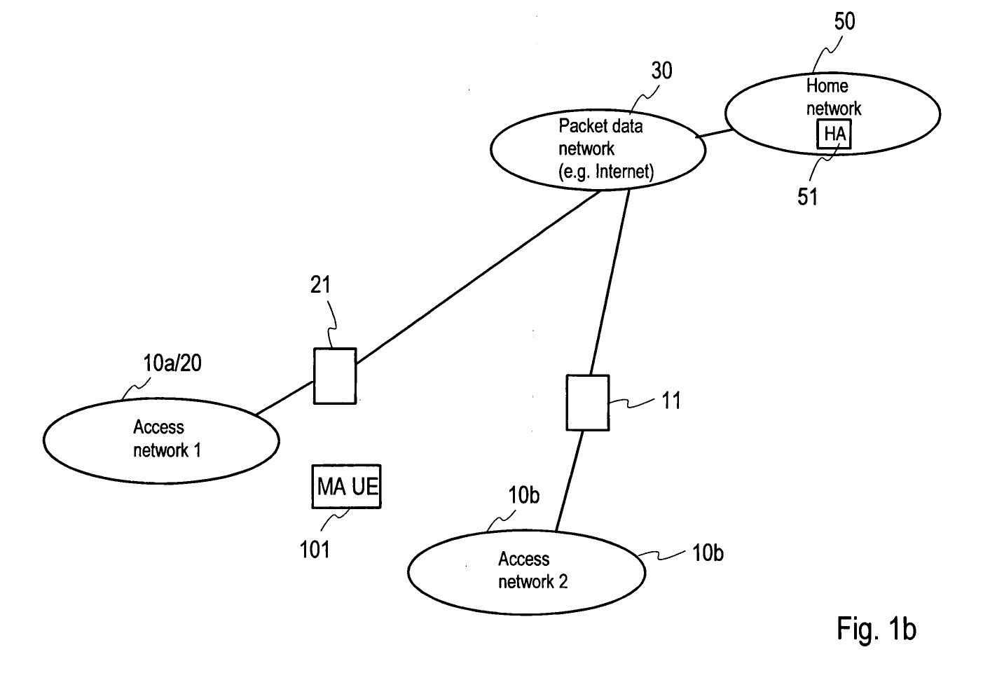

### DETAILED DESCRIPTION OF EMBODIMENTS OF THE INVENTION

In the following detailed description reference is, by way of example, made to a multi-access communications device, but it is appreciated that embodiments of the invention are applicable also in a situation where a communications devices loses communications via an access network temporarily. Losing communications via an access network may be due, for example, to the communications device being moved out of the coverage area of the access network.

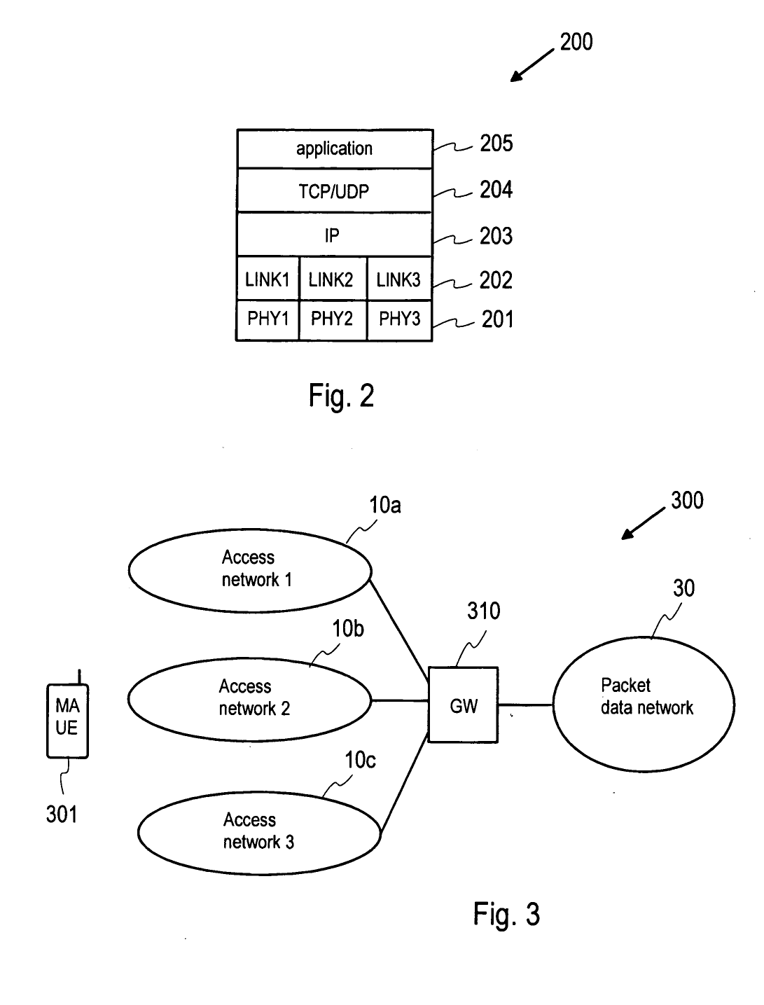

FIG. 2 shows schematically a protocol stack 200 of a multi-access communications device. The protocol stack 200 in FIG. 2 provides support for communications via three access technologies. The lowest protocol layer 201 relates to the physical medium and to medium access control. The second lowest protocol layer 202 relates to link control. For different access techniques, these protocol layers 201 and 202 are typically different, as shown in FIG. 2.

The protocol layer on the link layer 202 is the network layer 203. FIG. 2 mentions Internet Protocol (IP) as a specific example. The next protocol layer is the transport layer 204. In FIG. 2, Transmission Control Protocol (TCP) and User Datagram Protocol (UDP) are mentioned as examples, as these are typically used in connection with IP protocol. Applications generally reside in the application protocol layer 205.

FIG. 3 shows, as an example, a communications system 300, where embodiments of the present invention are applicable. The communications system 300 comprises, as an example, three access networks 10a, 10b and 10c. A gateway GW 310 provides access to a packet data network 30 through the various access networks. FIG. 3 shows also a multi-access communications device 301 provided with capability to use the three access networks and also with functionality to support session continuity.

In the communications system 300, the gateway 310 functions as an access router for the multi-access communications device towards the public data network 30, when the multi-access communications device 301 is communicating via one of the access networks 10a, 10b and 10c. In other words, the gateway 310 provides a network address for the multi-access communications device when the multi-access communications device is using one of the access networks 10a, 10b and 10c.

It is appreciated that the term access router above is in line with the Internet Protocol Version 6 (IPv6) terminology.

It is also appreciated that the communications system 300 provides functionality for assigning network addresses for communications devices communicating via the various access networks 10a, 10b, 10c from a common network address pool. This means that it is possible to assign the same network address for a communications device after it has changed access networks within the communications system 300.

The functionality relating to managing the common network address pool may be implemented in the gateway 310 or in further entities of the communications system 300.

When the access router to a data network does not change although the access network changes and there is provided a common pool of network addresses for communications devices using a plurality of access networks, it is possible to provide support for session continuity using embodiments of the invention. In embodiments of the invention, it is attempted to keep the network address of the multi-access communications device the same even when the multi-access communications device uses first a first access network and thereafter using a second access network. Furthermore, in the multi-access communications device the change in access technology is hidden from upper protocol layers.

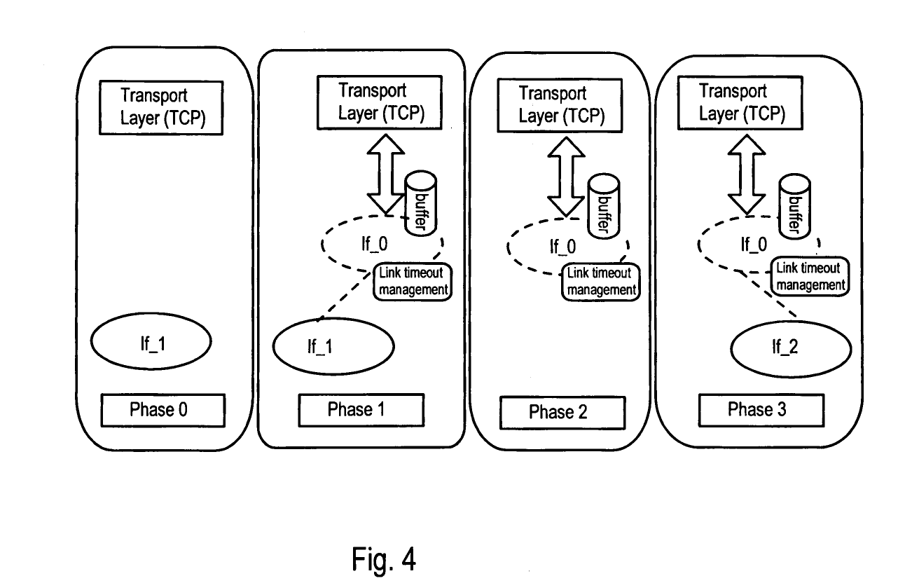

FIG. 4 shows a schematic diagram relating to supporting session continuity in a multi-access communications device 401. FIG. 4 shows some details of the network protocol layer 203. IP is used in FIG. 4 as an example of network protocol and TCP is used as an example of the protocol layer 204 above the network layer 203. In Phase 0, the communications device gains IP connectivity through a first access network 10a or access technology. This first access network can be, for example, WLAN. The corresponding network interface If_1 is configured with the relevant network parameters. For IP, these network parameters typically comprise the IP address of the communications device, information indicating a default gateway, and a DNS server.

Information about the default gateway and about other IP protocol stack configuration parameters (in other words, information about the settings for the interface) is usually obtained when activating a Packet Data Protocol (PDP) context (in GPRS) or by using Dynamic Host Configuration Protocol (DHCP).

In Phase 1 in FIG. 4, there is provided a virtual interface If_0 which is identical to the first interface If_1. This virtual interface is provided for upper protocol layers. In Phase 2, the multi-access communications device 301 loses the link to the first access network 10a, for example by moving out of coverage. The virtual interface If_0 acts temporarily as a ghost interface for the lost interface If_1 towards upper protocol layers. As an example of this acting as a ghost interface, the virtual interface buffers any data coming from upper protocol layers. The upper protocol layer may, at this point, notice an increase in response times, but they are not aware of the lost link. The virtual interface may also maintain a timer for measuring the time elapsed since the link was lost. The purpose of this timer is to limit the lifetime of the virtual interface. Should the timer value exceed a predefined threshold, upper protocol layers are typically informed of losing link connection. In this case the session is typically interrupted.

In Phase 3 in FIG. 4, the communications device gains IP connectivity again. The IP connectivity may be regained via the same first access network 10a or via a second access network 10b. The functionality discussed in connection with FIG. 4 is applicable to both situations. The communications device sets up a second interface If_2, and configures it using relevant network parameters. The network address for the communications device may be obtained from the communications system via the new (or regained) access network. Alternatively, the communications device may perform, for example, stateless IPv6 address autoconfiguration or Dynamic Host Configuration Protocol (DHCP). This means that the communications device provides to the network information about the network address it wishes to use. The communications device has stored information about the network address used in connection with interface If_1 at least in parameters of the virtual interface If_0, so information about the desired network address is available.

After the configuration of the second interface If_2 is complete, it is checked whether the settings of this second interface are in accordance with the settings of the virtual interface. The relevant settings are, at least, the network address assigned to the communications device and the default gateway. Other settings may differ. If the relevant settings are in accordance, communications can be resumed and data can be relayed between the virtual interface If_0 and the second interface If_2. If the settings of the second interface are not in accordance with those of the virtual interface, it is not possible to hide the change in access technology from upper protocol layers. In this case, the virtual interface will be flushed and transport sessions will be lost.

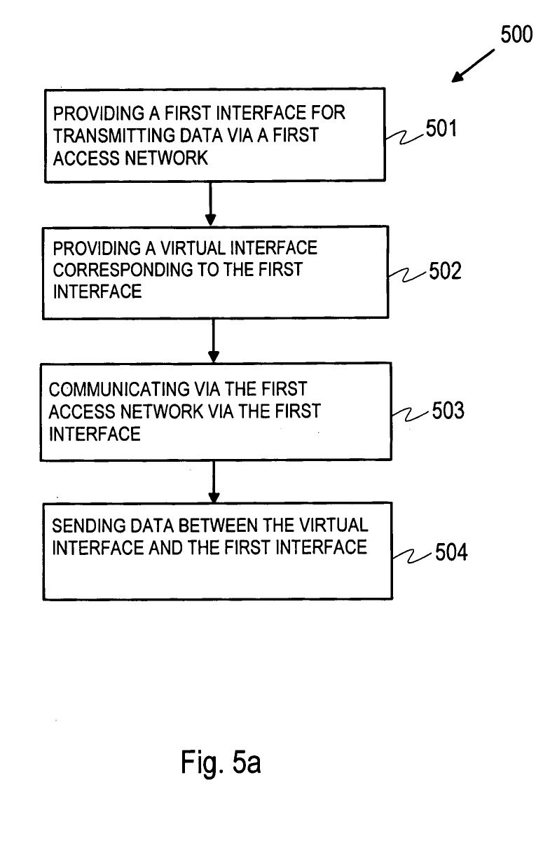

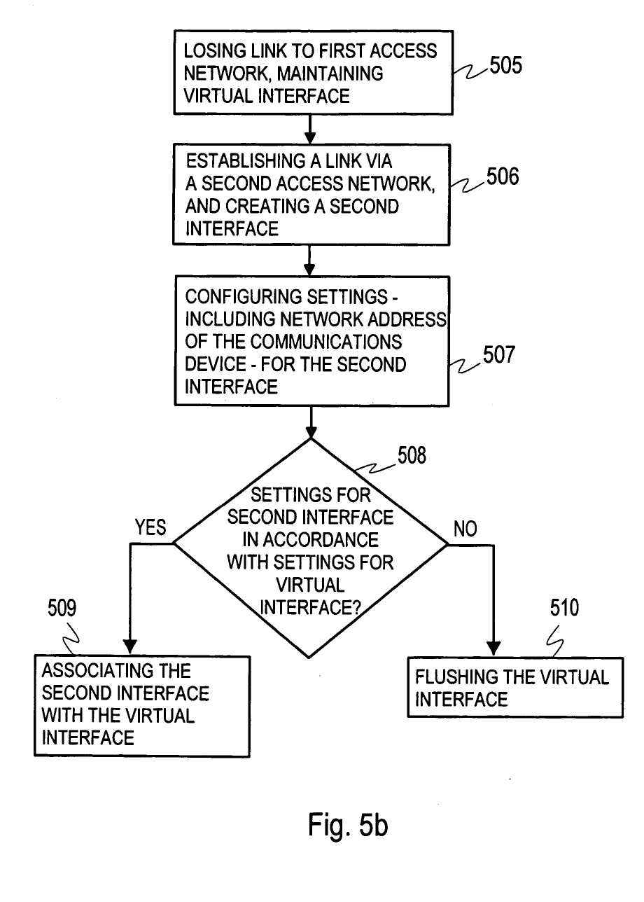

FIG. 5a shows a flowchart of a method 500 relating to providing in a communications device a virtual interface for hiding possible changes in access technologies or possible temporary loss of communications via an access network. In step 501, there is provided a first interface for transmitting data via an access network. This step 501 corresponds to Phase 0 in FIG. 4. In step 502, there is provided a virtual interface corresponding to the first interface. In step 503, the communications device is communicating via the access network using the first interface. In step 504, communications are carried out by sending data between the first interface and the virtual interface. Steps 502 to 504 correspond to Phase 1 in FIG. 4.

FIG. 5b shows further steps for the method 500. Similarly as FIG. 4, reference is here made to a multi-access communications device but the method steps are applicable also when losing temporarily connectivity via one access network. In step 505, the link via the first access network is lost, but the virtual interface is maintained. Step 506 thus corresponds to Phase 2 in FIG. 4. In step 506 a link is being established via a second access network (or again via the first access network), and a second interface is created for these communications. In step 507, various settings, including a network address of the communications device, are configured for the second interface. In step 508, it is checked whether the settings of the second interface are in accordance with settings of the virtual interface. If, for example, network addresses for communications devices in the first access network are assigned by a different network entity than network addresses for communications devices in the second access network, the network address for the second interface may be different from the network address in the virtual interface. In step 509, the second interface is associated with the virtual interface, if the settings of the second interface are in accordance with the settings of the virtual interface. Thereafter data is relayed between the second interface and the virtual interface. This situation corresponds to Phase 3 in FIG. 4. In step 510, if the settings for the second interface and the virtual interface are different, the virtual interface will be flushed and transport sessions will typically be lost.

The virtual interface functionality may be provided for a communications device as program code, for example, as a plug-in driver.

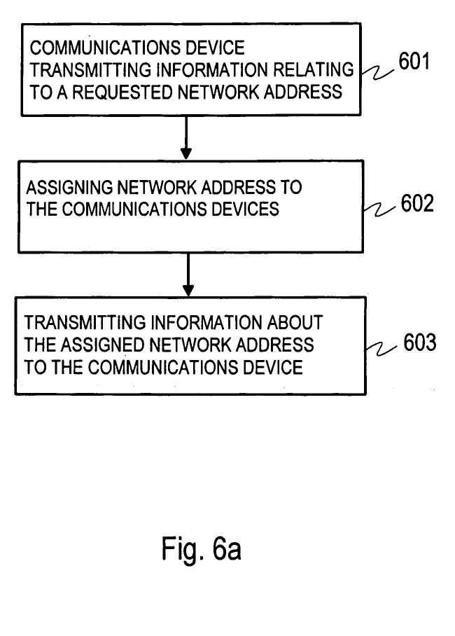

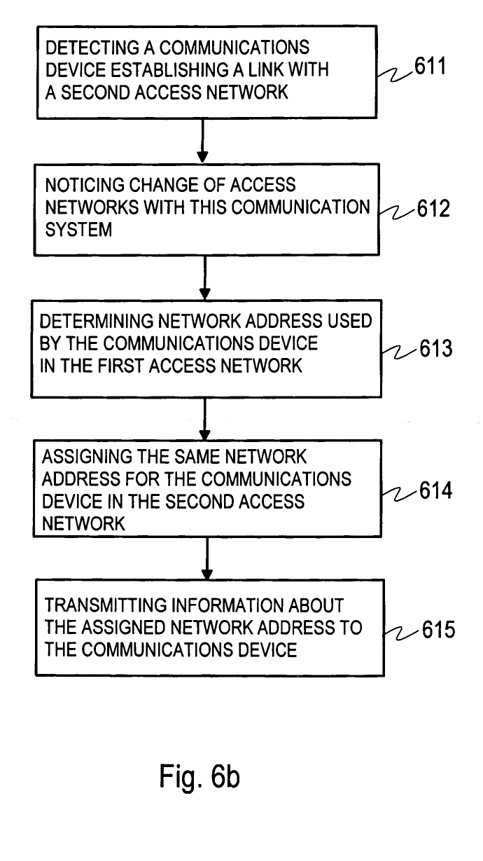

FIGS. 6a and 6b show more details about configuring the network address for the second interface in step 507. Again changing access network from a first network to a second network is used as an example. FIG. 6a relates to an embodiment, where the multi-access communications device is capable of transmitting to the network information relating to the desired network address. This is done in step 601. Thereafter the communications network assigns a network address to the communications device in step 602. If possible, the communications device is assigned the network address it requested. In step 603, the communications system provides information about the assigned network address to the communications device.

FIG. 6b relates to an alternative embodiment, where the communications network assigns to the communications device a network address without information of a desired network address. Alternatively, the communications network may ignore a network address request from the communications device. In step 611 the communications network detects a communication device establishing a link with the second access network In step 612, the communications network notices that the communications device is changing access network within the access networks of this communication system. Furthermore, the access networks share a common network element connecting them to the data network and providing a point-of-attachment for the communications device. The communications system determines in step 613 which network address the communications device used in the first access network. In step 614 the communications network assigns, from the common network address pool, the same network address for the communications device for use in the second access network. In step 615 the communication system transmits to the communications device information relating to the assigned network address.

It is appreciated that the communications network may use an identifier associated with the multi-access communications device for determining which network address the communications device has used earlier. One example of such an identifier is the International Mobile Subscriber Identifier (IMSI), but also other identifiers may be used. A communications system 300 may thus need to store information about the network addresses it assigns to communications devices together with identifiers associated with the communications devices. This information may be kept for a predetermined time period even after the communications with a communications device have been lost or terminated. This predetermined time period may vary, for example, from a few seconds to a few tens of seconds. This enables the communications system to determine whether a communications device establishing communications via an access network already has a network address assigned to it recently. If possible, the communications system does not assign the recently used network addresses to other communications devices before the predetermined time period has lapsed. There may be, however, situations where the network addresses need to be re-used before the predetermined time period has lapsed.

It is appreciated that for successfully supporting session continuity there may be need for functionality in accordance with embodiments of the invention in the multi-access communications device and in the communications system. If the communications system cannot provide a same access router and/or the same network address as earlier in use for the multi-access communications device 301, sessions are typically lost. On the other hand, if a multi-access communications device is not provided with the functionality relating to the virtual interface, it may not be able to maintain session even if the communication system is provided with functionality in accordance with an embodiment of the invention.

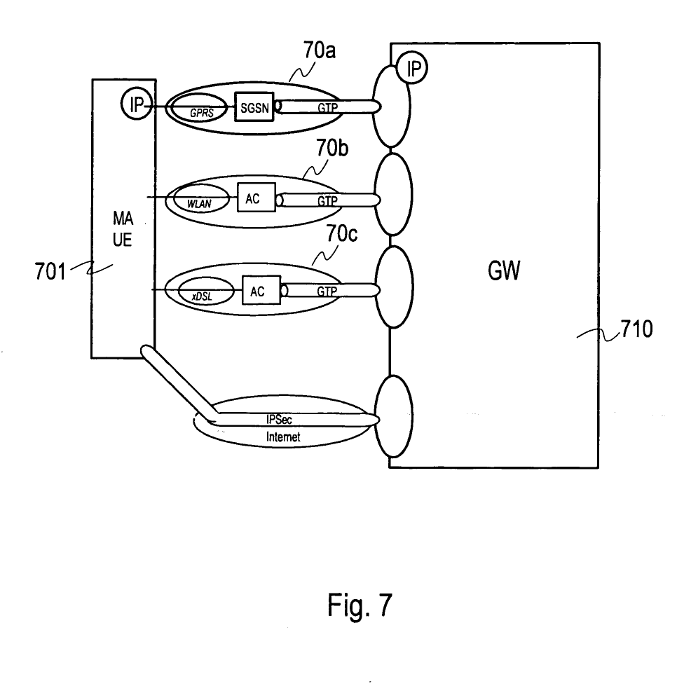

FIG. 7 shows a more detailed example of a multi-access architecture, where embodiments of the present invention are applicable. The gateway 710 is an access router supporting IP connectivity for communications devices through various access technologies. The gateway 710 connects a plurality of different access networks to IP network. The first access network 70a in FIG. 7 is a GPRS network, and the gateway 710 may thus provide also the functionality of a GGSN. The second access network 70b is a WLAN. The third access technology 70c is xDSL (Digital Subscriber Line technologies). A fourth option in FIG. 7 is an Internet protocol connection between the multi-access communications device 701 and the gateway 710. The gateway 710 may manage the common pool of network addresses discussed above.

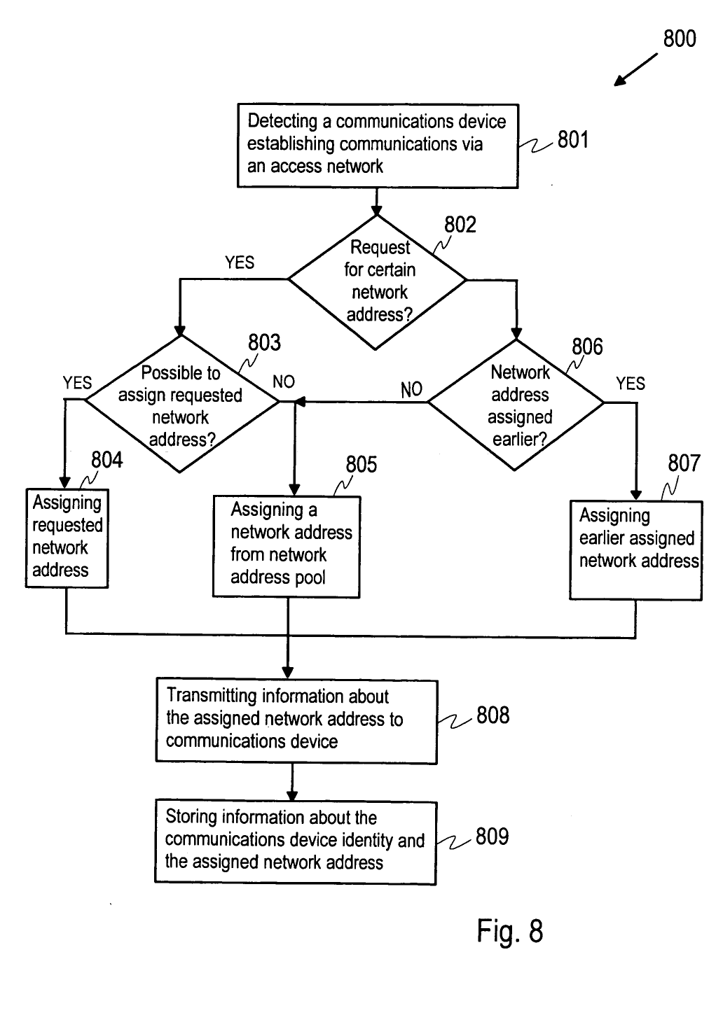

FIG. 8 shows a flowchart relating to a method 800 in accordance with a further embodiment of the invention. In step 801, a communications system detects a communications device establishing communications via an access network. In step 802 it is checked whether the communications device request a certain network address to be assigned to it. An example of detecting a communications device establishing communications is the receipt of the network address request. If a certain network address is requested, the communications system checks in step 803 whether it can assign the requested network address to the communications device. This checking typically includes checking, for example, that the communications system can handle traffic addressed to the requested network address and that the requested network address is not used by another communications device in the access network. The requested address is then assigned in step 804, or a network address from the pool of network addresses managed by the communications system is assigned to the communications device in step 805. If the communications device does not request a certain network address, the communications system checks in step 806 whether the communications device has been assigned a network address earlier on, typically within some predetermined time interval. In step 807 the earlier assigned network address is assigned to the communications device for use with the current access network (if the network address is available), otherwise in step 805 a network address from the network address pool managed by the communications system is assigned to the communications device. In step 808 information about the assigned network address is transmitted to the communications device. Thereafter the communications are carried out in a normal manner known to a skilled person. In step 809 the communications system stored information about the identity of the communications device and about the assigned network address. This information may be erased from the storage after a predetermined time period has lapsed since the communications with the communications device were lost or terminated.

It is appreciated that the network address pool mentioned in step 805 may relate to one access network or to a plurality of access networks.

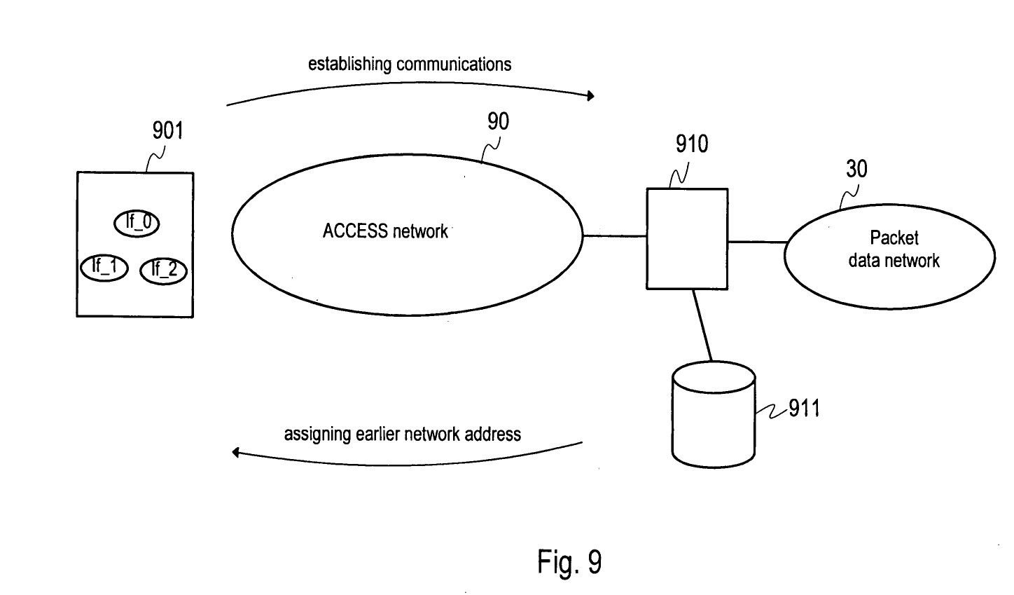

FIG. 9 shows schematically a communications system 900 and a communications device 901 providing functionality in accordance with an even further embodiment of the invention. The communications device 901 provides a first interface If_1 for transmitting data via an access network and a virtual interface If_0 corresponding to the first interface. The communications device 901 communicates via an access network 90 using the first interface If_1, and internally the communications device sends data between the first interface If_1 and the virtual interface If_0. The communications device 901 is typically configured to maintain the virtual interface when losing communications via the first interface. The communications device 901 is also typically configured to create a second interface If_2 for communications via the same access network or via a further access network in connection with establishing communications after losing communications via the first interface If_1.

The communications system 900 has an access network 90 and a network element 910 connecting the access network 90 to a packet data network 30. The network element 910 typically provides access router functionality, and it has storage 911 for storing information about identities of communications devices and about network addresses assigned to the communications devices. It is appreciated, however, that the access router functionality and the storage may be implemented alternatively elsewhere in the communications system 900 than in the network element 910.

The communications system 900 is configured to connect the access network 90 to a packet data network for providing connectivity to communications devices. The communications system is also configured to detect a communications device 901 establishing communications via the access network 901, and to determine a network address used earlier by the communications device. If possible, the communications system 900 retains said network address for the communications device 901 when the communications device 901 communicates via the access network 90.

The communications system 900 may include a plurality of access networks. In this case, one network element typically connects these access networks to the packet data network, similarly as shown in FIG. 7. Furthermore, in this case the communications system 900 has a common pool of network addresses for use by communications devices communicating via an access network of the plurality of access networks.

It is appreciated that the term communications device is intended to cover any devices receiving and/or transmitting signals from and/or to a communications system. The term is intended to cover, for example, user equipment, mobile telephones, mobile stations, personal digital assistants, laptop computers and the like. A communications device may also be a device not directly used by an end-user, for example, a server computer equipped with suitable transceiver equipment for communications via a communications network.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A method for supporting session continuity, the method comprising:
providing a first interface in a communications device for transmitting data via an access network;
providing in the communications device a virtual interface corresponding to the first interface;
communicating via the access network using the first interface; and
sending data between the first interface and the virtual interface.

2. A method as defined in claim 1, comprising maintaining the virtual interface when losing communications via the first interface.

3. A method as defined in claim 2, comprising buffering data to be sent from the virtual interface to the first interface when the communications via the first interface are lost.

4. A method as defined in claim 2, comprising limiting a duration of time of maintaining the virtual interface if the communications via the first interface are lost.

5. A method as defined in claim 1, comprising continuing to send data between the first interface and the virtual interface when communications via the first interface are resumed.

6. A method as defined in claim 1, comprising creating a second interface in the communications device for communications via the access network or another access network.

7. A method as defined in claim 6, comprising configuring a network address of the communications device for the second interface.

8. A method as defined in claim 7, comprising retaining the network address used in the first interface for the second interface.

9. A method as defined in claim 7, comprising
determining, in a communications network, the network address used by the communications device for communications via the access network, and
assigning the network address used by the communications device for the communications via the access network as the network address of the communications device for the second interface.

10. A method as defined in claim 9, comprising using an identifier relating to the communications device in determining the network address used for the communications via the access network.

11. A method as defined in claim 7, comprising requesting the network address of the communications device used in the virtual interface as the network address of the communications device for the communications using the second interface.

12. A method as defined in claim 6, comprising checking that a network address assigned for use with the second interface is in accordance with the network address assigned for use with the virtual interface.

13. A method as defined in claim 12, comprising associating the second interface with the virtual interface, if settings of the second interface are in accordance with settings of the virtual interface.

14. A method as defined in claim 5, comprising sending data between a second interface and said virtual interface.

15. A computer program embodied on a computer-readable medium for controlling a computing device, the computer program controls the computing device to perform the steps of:
providing a first interface in a communications device for transmitting data via an access network;
providing in the communications device a virtual interface corresponding to the first interface;
communicating via the access network using the first interface; and
sending data between the first interface and the virtual interface.

16. A computer program as defined in claim 15, comprising controlling the computing device to perform the step of reading from said computer readable medium.

17. A communications device configured to
provide a first interface for transmitting data via an access network;
provide a virtual interface corresponding to the first interface;
communicate via the access network using the first interface; and
send data between the first interface and the virtual interface.

18. A communications device as defined in claim 17, configured to maintain the virtual interface when losing communications via the first interface.

19. A communications device as defined in claim 17, configured to continue sending data between the first interface and the virtual interface when the communications via the first interface are resumed.

20. A communications device as defined in claim 17, configured to create a second interface in the communications device for communications via the access network or via another access network.

21. A communications device as defined in claim 20, configured to retain a network address used for the first interface for the second interface.

22. A method for supporting session continuity, the method comprising:
detecting a communications device establishing communications via an access network;
determining a network address used earlier by the communications device; and
retaining said network address when the communications device communicates via said access network.

23. A method as defined in claim 22, comprising assigning to the communications device for the access network the network address used earlier by the communications device.

24. A method as defined in claim 23, comprising transmitting information relating to the network address to the communications device.

25. A method as defined in claim 22, comprising receiving a request to be assigned the network address indicated in the request from the communications device.

26. A method as defined in claim 22, comprising detecting the communications device changing a plurality of access networks in connection with establishing the communications via the access network.

27. A method as defined in claim 22, comprising detecting the communications device establishing communications via the access network as earlier.

28. A method as defined in claim 22, comprising using an identifier relating to the communications device in determining the network address used earlier by the communications device.

29. A method as defined in claim 22, comprising:
providing, in the communications device, a first interface for transmitting data via the access network, and
providing, in the communications device a virtual interface, wherein the virtual interface corresponds to a second interface relating to earlier communications.

30. A method as defined in claim 29, comprising checking that the network address configured for the communications device for the first interface is in accordance with a virtual interface network address configured for the virtual interface.

31. A method as defined in claim 29, comprising
communicating via the access network using the first interface, and
sending data between the first interface and the virtual interface.

32. A network element configured to:
connect at least one access network to a packet data network;
detect a communications device establishing communications via an access network;
determine a network address used earlier by the communications device; and
retain said network address for the communications device when communicating via said access network.

33. A network element as defined in claim 32, configured to
connect a plurality of access networks to the packet data network, and
provide a common pool of network addresses for communications devices communicating via access networks of the plurality of access networks.

34. A communications system comprising:
at least one network element, said at least one network element configured to
connect an access network to a packet data network;
detect a communications device establishing communications via said access network;
determine a network address used earlier by the communications device; and
retain said network address for the communications device when communicating via said access network.

35. A communications system comprising:
at least one communications device, wherein said at least one communications device is configured to
provide a first interface for transmitting data via an access network,
provide a virtual interface corresponding to the first interface,
communicate via the access network using the interface, and
send data between the first interface and the virtual interface.

36. A communications system comprising at least one access network, said communications system configured to
connect an access network to a packet data network for providing connectivity to communications devices;
detect a communications device establishing communications via said access network of the communications system;
determine a network address used earlier by the communications device; and
retain said network address for the communications device when communicating via said access network.

37. A communications system as defined in claim 36, configured to
connect a plurality of access networks to a packet data network, and
provide a common pool of network addresses for said communications devices communicating via access networks of the plurality of access networks.

38. A communications system comprising at least one access network, said computer system configured to
connect an access network to a packet data network for providing connectivity to communication devices;
detect a communication device establishing communications via said access network of the communications system;
determine a network address used earlier by the communications device; and
retain said network address for the communications device when communicating via said access network,
wherein said communications device is configured to
provide a first interface for transmitting data via the access network,
provide a virtual interface corresponding to the first interface,
communicate via the access network using the first interface, and
send data between the first interface and the virtual interface.

39. A system for supporting session continuity, the system comprising:
first providing means for providing a first interface in a communications device for transmitting data via an access network;
second providing means for providing a virtual interface corresponding to the first interface in the communications device;
communicating means for communicating via the access network using the first interface; and
sending means for sending data between the first interface and the virtual interface.

40. A system for supporting session continuity, the system comprising:
connecting means for connecting an access network to a packet data network for providing connectivity to communications devices;
detecting means for detecting a communications device establishing communications via an access network;
determining means for determining a network address used earlier by the communications device; and
retaining means for retaining said network address when the communications device communicates via said access network.
